(19) United States
(12) Patent Application Publication
(10) Pub. No.: US 2008/0074516 A1
(43) Pub. Date: Mar. 27, 2008

(54) Method for calculating gamma correction values and image pick-up device having a corresponding gamma application device

(76) Inventor: Arndt Bussmann, Duisburg (DE)

Correspondence Address: MCNAIR LAW FIRM, P.A., P.O. BOX 10827, GREENVILLE, SC, 29603-0827, US

(21) Appl. No.: 11/890,053

(22) Filed: Aug. 3, 2007

(30) Foreign Application Priority Data
Aug. 3, 2006 (DE) 102006036305.1

(51) Int. Cl. H04N 5/202

(52) U.S. Cl. 348/254; 348/E05.074

(57) ABSTRACT

Proposed is a system for the calculation of gamma correction, which enables an improved display for images, taken under various conditions. Further, the invention accepts the purpose of making available an image processing apparatus, which makes use of this method for the calculation of gamma correction values. The principal concept of the present invention is to be found therein, in that instead of a standardized, fixed gamma correction, a dynamic gamma correction for individual images is created on the basis of image-specific statistical data pertaining to these individual images. By these means, the user of the image is placed in a situation, wherein the user is able to exploit the brightness dynamic realm better than previously.

### CROSS-REFERENCE TO RELATED APPLICATION

This application claims priority from German Patent Application No. 102006036305.1 filed Aug. 3, 2006.

### FIELD OF THE INVENTION

This invention is directed to a system for providing gamma corrected electronic images for internal display in a vehicle capture from an external image capture device so that the operator of a vehicle can be provided with an image of objects exterior to the vehicle.

### BACKGROUND

Image capture and display devices are used in many applications, including motor vehicles for capturing electronic images of external objects for display in the interior of a vehicle. These images are particularly helpful when maneuvering a vehicle newer or around objects. However, the environmental conditions under which the images are captured can vary greatly from full sunlight to dark shadows. Therefore it is advantageous to have a image display system that displays images with sufficient detail to assist the operator of the vehicle in maneuvering the vehicle.

In modern industrial image processing, although also appearing in many regions of motor vehicle activities, image processing systems are desired, which in different applications, provide high quality presentations and images. A gamma-correction offers possibilities for improvement in this regard. Image projection systems, such as RGB and LCD monitors have different brightness gradations and require correction measures frequently, in order to present an image in its best sense. In an ideal manner, a display apparatus would rate the decree of brightness for black as 0, and ascribe to a white reproduction a 1, with interposed values being evaluated as successively increasing or decreasing values of gray. Such a rated scale is representative, respectively, of a gamma rating in the same range. Actual cameras and image reproductive systems possess no such linear function. Most such instruments burden the non-linear characteristics of a display means, for example, an LCD screen, or CCDs of a camera. The results of these non-linear characteristics are that displayed images lack detail, be too dark or too light so that detail of the image is lost. So that, in a case where the capture of an image and the projection of the same is concerned, the least possible brightness data might be lost, or be over emphasized, apparatuses having non-linear input characteristics generally offer a possibility for gamma correction to acquire a linearization of displayed imaging.

Traditionally, image display systems possess an adjustable, but nevertheless a standard, fixed gamma corrective means. This is used to display the image with certain brightness so that reproduction is capable by the display equipment in use. For example, the non-linearity of a television tube which has a gamma value of 2.2 has to be corrected by a value of gamma=0.45. When the image capture device has the same gamma of the display device, acceptable display of image can be reached with our significant gamma correction. When pictures are taken, in cases where the brightness dynamics are greater than have been assumed, such an arrangement can show considerable disadvantages. Considering image quality in cases troubled by high brightness dynamics and reflective interferences, the resulting displays can evidence lighting qualities which are over or under optimal levels. In such instances, the display equipment shows surfaces which tend toward either white or black. In many cases, this effect is notably emphasized by the commonly used statistical gamma correction, even though the image taking system, i.e. a camera, has acquired image data of considerable importance which will not be used in display.

Therefore, it is an objective of the present invention to make available a method for the calculation of gamma correction values, which makes possible a better image reproduction.

### SUMMARY OF THE INVENTION

The present invention is provided by providing a gamma corrected exterior viewing apparatus comprising: an image capturing device for mounting on a vehicle for capturing an electronic image exterior to the vehicle; a computer readable medium in communication with the image capturing device; an interior display device in communication with the computer readable medium for displaying an electronic image captured by the image capturing device; and, a set of computer readable instructions embodied in the computer readable medium for receiving electronic image information representing the electronic image, performing an image specific statistical analysis on the electronic image information, determining a gamma correction value according to the image specific statistical analysis so that the electronic image can be displayed on the display device according to the gamma correction value.

The invention can include a set of computer readable instructions for displaying an electronic image according to the electronic image information and the gamma correction value on the display device, displaying a second electronic image according to a second electronic image information and the gamma correction value on the display device; receiving a plurality of electronic image information from the image capturing device, performing image specific statistical analysis on each electronic image information, and determining a gamma correction value according to the image specific statistical analysis for each electronic image information; determining a total gamma correction value according to each of the image specific statistical analysis results; performing an average, median and gradation luminance dispersion analysis for each electronic image information; calculating, average, median and gradation analysis results from the average, median and gradation luminance dispersion analysis, summing the gamma correction values, and calculating a total gamma correction value from the average, median and gradation analysis results and the summed gamma correction values; determining a brightness value of the electronic image information; performing luminance dispersion analysis; and performing an average, median, and gradation luminance dispersion analysis.

The present invention can include a vehicle carrying the image capturing device, the interior display device, and the computer readable instructions. The invention can include a mirror assembly wherein the image capturing device is carried by the mirror assembly.

### DESCRIPTION OF THE DRAWINGS

The invention will be more readily understood by referring to the specification which includes the following figures:

FIG. 1 is a diagram of the invention; and,

FIG. 2 is a flow chart of the invention.

### DESCRIPTION OF THE PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums.

The terms “host” and “server” may be hardware, software, or combination of hardware and software that provides the functionality described herein. This invention thereby allows multiple users, being geographically dispersed, to interact with data relating to physical characteristics of manufactured products using a system that ensures the precise and accurate conveyance of such information (data).

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means to implement the functions specified in the flowchart block or blocks. Computer program instructions may also be loaded onto a computer or other programmable apparatus to produce a computer executed process such that the instructions are executed on the computer or other programmable apparatus providing steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

The invention concerns a system for displaying images using gamma correction values as well as an image processing system, which is required for the execution of the said method for the calculation of gamma correction values.

Especially present in modern industrial image processing, although also appearing in many regions of motor vehicle activities, image processing systems are desired, which in different applications, provide high quality presentations. A gamma-correction offers possibilities for improvement in this regard. Image projection systems, such as RGB and LCD monitors have different brightness gradations and require correction measures frequently, in order to present an image in its best sense. In an ideal manner, a display apparatus would rate the decree of brightness for black as 0, and ascribe to a white reproduction a 1, with interposed values being evaluated as successively increasing or decreasing values of gray. Such a rated scale is representative, respectively, of a gamma rating in the same range. Actual cameras and image reproductive systems possess no such functional linearity. Most such instruments burden the non-linear characteristics of a display means, these being, for example, an LCD screen, or CCD chips of a camera, with the role of causing the disturbing non-linearity. So that, in a case where the capture of an image and the projection of the same is concerned, the least possible brightness data might be lost, or be over emphasized, apparatuses having non-linear input characteristics generally offer a possibility for gamma correction to acquire a linearization of displayed imaging. In the case of apparatuses, which possess image converter facilities for different colors, the normal practice possibly calls for a gamma correction for each single color channel.

Up to this time and on this account, applied image pickup systems possess an adjustable, but nevertheless a standard, fixed gamma corrective means. This is used, as a rule, to bring the captured image into such brightness reproduction capabilities as are possesses by the display equipment in use. Classically, at the time of the television tube, the physically conditioned non-linearity of the image tube with a gamma of 2.2 has been corrected by a value of 0.45. Using a camera, which approaches the same area of brightness dynamics that the display apparatus has, can lead to acceptable results. When pictures are taken, in cases where the brightness dynamics are greater than have been assumed, such an arrangement can show considerable disadvantages. Considering image quality in cases troubled by high brightness dynamics and reflective interferences, the resulting displays can evidence lighting qualities which are over or under optimal levels. In such instances, the display equipment shows surfaces which tend toward either white or black. In many cases, this effect is notably emphasized by the commonly used statistical gamma correction, even though the image taking system, i.e. a camera, has acquired image data of considerable importance which will not be used in display.

On this account, it is the purpose of the present invention to make available a method for the calculation of gamma correction values, which makes possible a better image reproduction from various display equipment. Further, it is another purpose of the present invention to propose an image processing system, which this said method requires for the application of the calculations for the dynamic gamma correction values.

The principal concept of the invention is to be found therein, in that instead of a standard, unchangeable gamma correction, a dynamic gamma correction value for individual images is to be made on the basis of specific statistical data relating to these specific images. If this be done, then the user is in the position of being able to employ the brightness dynamics of the image taking system better than previously. Thus it may be assured, that the data retained in the image which is captured and is to be shown can be completely exploited to its fullest extent. The results of this statistical evaluation of individual images are put to use in order that by means of specific obtaining of gamma corrective values, relevant image features may be emphasized.

In the case of conventional cameras, the lighting regulations are based, as a rule, on data, which is computed from the corresponding brightness histogram and the relevant values, such as lighting which may be average, medium or dispersed, in accord with the current conditions. These statistic image data, which are necessary for the regulation of lighting, or more exactly expressed, the effects of the dispersion of the brightness, i.e. the luminescence dispersion, of the individual images are used, in order that custom-fit, dynamic gamma correction values become available for the respectively individual images.

In accord with an advantageous embodiment of the invention it is possible that an underexposed image can be brightened by a diminution of the gamma value and an overexposed image can be darkened by increasing the gamma value.

In the course of definite applications, it can be advantageous to compute the statistical values on the basis of a majority of individual images. In the case of specific applications, it can be sufficient to employ the same adapted gamma correction value for a majority of successively following pictures. In this way the time and expense of calculation time is reduced.

The following areas of application are available for the invention for: inspection and positioning systems, which require reliable object identification and classification based on reliable image information, supervisory (monitoring) tasks in the automotive industry, such as, for example, the inspection of the interior space of motor vehicles, and/or traveled road inspection, pre-crash sensors and cameras for maneuvering in reverse, and general supervision tasks in the area of the video based monitoring technology, for example, CCTV.

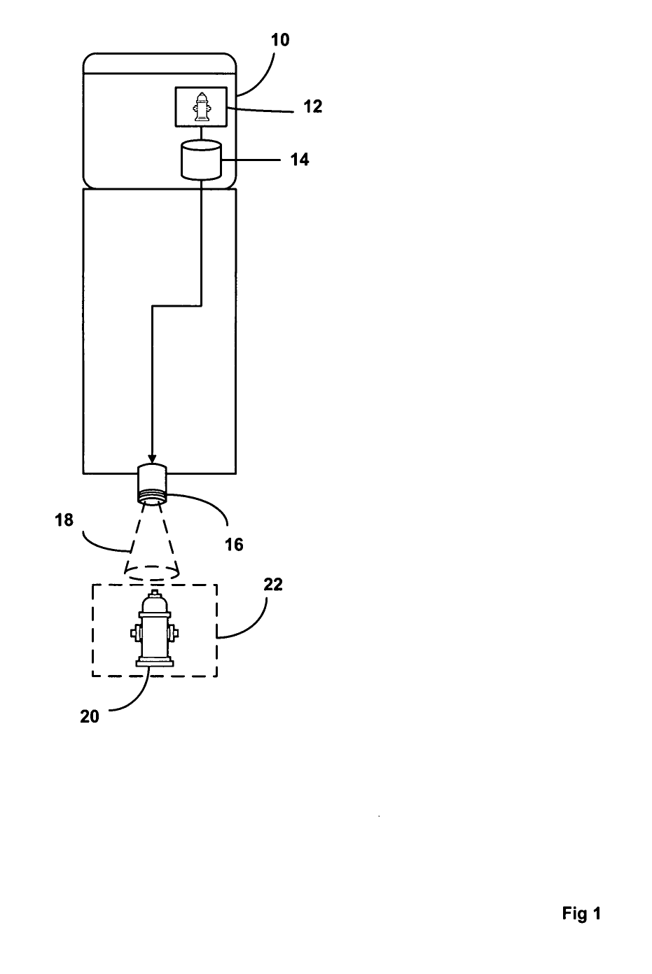

FIG. 1 shows a vehicle 10 having a display device 12 in communications with a computer readable medium 14. An image capture device 16 is in communications with the computer readable medium. The field of view of the image capture device 18 can capture am image of an object 20. The environment 22 of the object can be light, dark, in full sun, in shadows, or other lighting conditions that affect the way that the image capture device captures the visual information of the object. Once the image capture device captures an image, the image information is transmitted to the computer readable medium and computer readable instructions embodied in the computer readable medium can calculate the gamma correction from an image specific statistical analysis of the image and can then display the object with gamma correction.

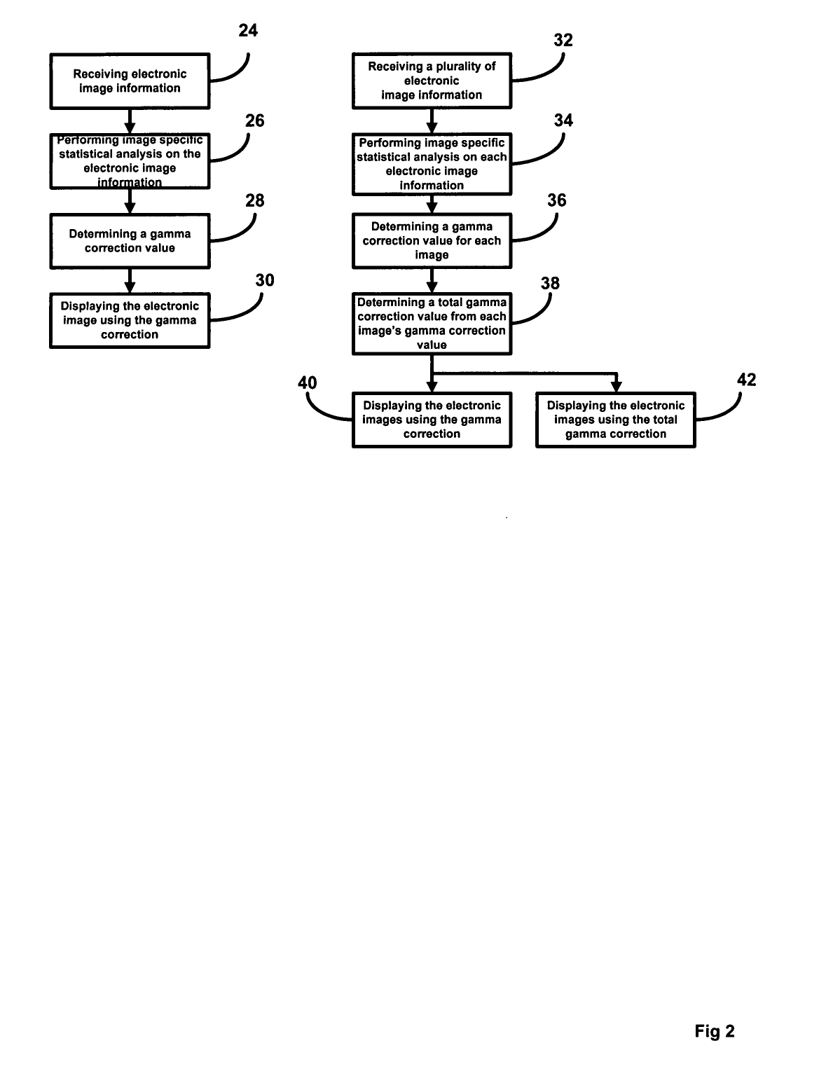

FIG. 2 shows that at 24 electronic information is received by the computer readable instructions. An image specific analysis if preformed at 26 and a gamma correction value is determined at 28. The image is displayed using the gamma correction value at 30.

A plurality of image information is received at 32 and image specific statistical analysis is preformed for each image information at 34. A gamma correction value is calculated for each image information at 36. The total gamma correction value from each image information is calculated at 38. The image is displayed using each image gamma correction value at 40. Further, each image can be displayed at 42 using the total gamma value. It should be noted that images can be displayed using each images specific gamma correction value or that a specific gamma value can be used to display each image. Further, the gamma value calculated for a first image can be used to display a second image.

Image receiving device 16 has an image sensor and image-data for capturing a multiplicity of individual images. The image information can be a identified on a pixel-wide basis, namely, for instance, as P(x, y), having a column location x and a row location y. The image data can be designated as the so-called RGB-data (i.e., red, green and blue components). Alternately these data can be known as luminescence-color components (for example, YUV or YCrCb and similar formats). Since the differing forms of acquired data, due to intermixing, cannot be used as a computation base, in the following text, terms relating to luminescent color components will be used. The brightness, that is, the luminescence of each individual image point, typically, Y(x, y), is directly proportional to the duration period of the adjusted illumination, namely tᵢₙₜ and the chosen reinforcement would be designated vᵢₙₜ, as long as there is no under or over exposure at the image point.

The image data acquired by the image receiving apparatus, in regard to individual images, are, with consideration given to their luminescence-color components, evaluated in computer readable instructions for performing statistical analysis. The computer readable instructions calculate from the luminescence-color components of the image data of an image with n columns and m lines, therewith mn pixels, the corresponding probability characteristics such as average value, the median quantity and the dispersion effect of the individual components. These characteristics now computed in the computer readable instructions can also be manipulated for lighting control based upon the duration of the image receiving apparatus. As a second, simultaneous step, the calculated characteristics are also be used to calculate a gamma correction value. In this gamma correction value can further be based upon calculations are made on the basis of the thereto transferred characteristics to obtain a gamma correction value for the current individual images. The probability characteristic of the luminescence is:

1. Average Value

$$\overline{Y} = \frac{1}{n \cdot m} \cdot ( {\sum }_{x}^{n} ( {\sum }_{y}^{m} Y ( x , y ) ) ) \qquad ( 1 )$$

2. Median

$$\tilde{Y} = \{ \begin{matrix}{Y}_{Sort} ( k ) & \ddot{fur} & k = \frac{n \cdot m + 1}{2} Λ k ∈ ℕ \\ \frac{{Y}_{Sort} ( k ) + {Y}_{Sort} ( k + 1 )}{2} & \ddot{fur} & k = \frac{n \cdot m}{2} Λ k ∈ ℕ\end{matrix} \qquad ( 2 )$$

The value of Y is the total of all the luminance values.
Y(x,y)εYxεNyεNx≦ny≦m (3)

These values can be sorted through the function Yₛₒᵣₜ₍ₗ₎ and so presented.
Y_{Sort}(1)=min(Y) (4)
Y_{Sort}(l)≦Y_{Sort}(l+1) [symbol] Y_{Sort}(l)εYl≦n·mlεN (5)

3. Dispersion

$${s}_{\tilde{Y}}^{2} = \frac{I}{n \cdot m - 1} \cdot ( {\sum }_{x}^{n} ( {\sum }_{y}^{m} {( Y ( x , y ) - \overline{Y} )}^{2} ) ) \qquad ( 6 )$$

The computer readable instructions calculate the gamma value for the corresponding optimal value using the general formulation:

$$γ = {\sum }_{r \geq 0}^{∞} ( {γ}_{\overline{Y} , r} + {γ}_{\tilde{Y} , r} + {γ}_{{s}_{\overline{Y}}^{2} , r} + {γ}_{int , r} ) \qquad ( 7 )$$

The running variables r are complete numbers and the individual sums are as follows:

$$\begin{matrix}{γ}_{\overline{Y} , r} = {rect}_{1} ( \frac{{α}_{{\overline{Y}}_{r}} \cdot \overline{Y} - {β}_{{\overline{Y}}_{r}} \cdot {\overline{Y}}_{Soll} - δ {\overline{Y}}_{r}}{Δ {\overline{Y}}_{r}} ) \cdot [ {\sum }_{u \geq 0}^{∞} {a}_{u , r} \cdot {( {α}_{{\overline{Y}}_{r}} \cdot \overline{Y} - {β}_{{\overline{Y}}_{r}} \cdot {\overline{Y}}_{Soll} )}^{u} + {log}_{q} ( {\sum }_{u \geq 0}^{∞} {b}_{u , r} \cdot {\overline{Y}}^{u} ) \cdot {( {log}_{q} ( {\sum }_{u \geq 0}^{∞} {c}_{u , r} \cdot {\overline{Y}}_{Soll}^{u} ) )}^{- 1} + {Γ}_{{\overline{Y}}_{r}} ] & ( 8 ) \\ {γ}_{\tilde{Y} , r} = {rect}_{1} ( \frac{{α}_{{\tilde{Y}}_{r}} \cdot \tilde{Y} - {β}_{{\tilde{Y}}_{r}} \cdot {\tilde{Y}}_{Soll} - δ {\tilde{Y}}_{r}}{Δ {\tilde{Y}}_{r}} ) \cdot [ {\sum }_{u \geq 0}^{∞} {d}_{u , r} \cdot {( {α}_{{\tilde{Y}}_{r}} \cdot \tilde{Y} - {β}_{{\tilde{Y}}_{r}} \cdot {\tilde{Y}}_{Soll} )}^{u} + {log}_{q} ( {\sum }_{u \geq 0}^{∞} {e}_{u , r} \cdot {\tilde{Y}}^{u} ) \cdot {( {log}_{q} ( {\sum }_{u \geq 0}^{∞} {f}_{u , r} \cdot {\tilde{Y}}_{Soll}^{u} ) )}^{- 1} + {Γ}_{{\tilde{Y}}_{r}} ] & ( 9 ) \\ {γ}_{{s}_{\overline{Y}}^{2} , r} = {rect}_{1} ( \frac{{α}_{{s}_{\overline{Y} r}^{2}} \cdot {s}_{\overline{Y}}^{2} - {β}_{{s}_{\overline{Y} r}^{2}} \cdot {s}_{\overline{Y} Soll}^{2} - δ {s}_{\overline{Y} r}^{2}}{Δ {s}_{\overline{Y} r}^{2}} ) \cdot [ {\sum }_{u \geq 0}^{∞} {g}_{u , r} \cdot {( {α}_{{s}_{\overline{Y} r}^{2}} \cdot {s}_{\overline{Y}}^{2} - {β}_{{s}_{\overline{Y} r}^{2}} \cdot {s}_{{\overline{Y}}_{Soll}}^{2} )}^{u} + {Γ}_{{s}_{{\overline{Y}}_{r}}^{2}} ] & ( 10 ) \\ {γ}_{int , r} = {rect}_{1} ( \frac{{t}_{int} - {δ}_{{t}_{int , r}}}{Δ {t}_{intr}} ) \cdot [ {\sum }_{u \geq 0}^{∞} {h}_{u , r} \cdot {t}_{int}^{ur} + {Γ}_{{t}_{int r}} ] + {rect}_{1} ( \frac{{v}_{int} - δ {v}_{int r}}{Δ {v}_{int r}} ) \cdot [ {\sum }_{u \geq 0}^{∞} {i}_{u , r} \cdot {v}_{int}^{u} + {Γ}_{{v}_{int r}} ] & ( 11 )\end{matrix}$$

The rect₁ function is defined as:

$${rect}_{1} ( z ) = \{ \begin{matrix}1 & \ddot{fur} & 0 \leq z \leq 1 \\ 0 & \ddot{fur} & z > 1 {⩔}_{z} < 0\end{matrix} \qquad ( 12 )$$

The coefficients and variables used in these functions have the following meaning:

Gamma adaption basis summation:

The gamma adaption basis summation λ y̅,r encompasses the functional dependency of the gamma value, relative to the true average value Y̅ and the set average value of the luminescence Y̅soll. Correspondingly, the gamma adaption basis summation γ y̅,r encompasses the functional dependency of the gamma value, relative to the true median value \tilde{Y} and the set value of the luminance \tilde{Y}soll. The functional dependency of the dispersion is obtained through the gamma adaption basis summation γsᵣ², relative to the true dispersion s_{y}² and the set dispersion of the luminance s_{Y}²soll. Internal sensor parameters, such as the duration of illumination tᵢₙₜ and the internal reinforcement vᵢₙₜ are arrived at through the gamma adaption basis summation γint, y.

The designated value for the average, median and dispersion characteristics is to be calculated from the current application.

Weight coefficients:

The weight of a respective real value is found in accord with the coefficients αYr, α\tilde{Y}r and αs_{Yr}². The set value appropriate thereto shows coefficients for weight as βYr, γ\tilde{Y}r, and βs_{Yr}².

Offsets:

Each gamma adaption basis summand governs an adjustable offset within the respective series of potentials. These are the summands: Γ Y̅r, Γ\tilde{Y}r, ΓS_{Yr}², Γt int r and Γv int r,

Potential series development coefficients:

The coefficients a_{uY}, b_{uY}, c_{uY}, d_{uY}, f_{uY}, g_{uY}, h_{uY} and i_{uY} are the development coefficients of the current potential series, which are required in order to be able to determine application-specific functional dependency,

Window of evaluation:

Each of the employed potential series can be brought into and out of the excess reflective situation by means of the evaluation function. The current widths of the evaluation window determine the parameters: ΔΓ Y̅r, ΔΓ\tilde{Y}r, ΔS_{Yr}², Δt int r and Δv int r. The planar displacement of the window of evaluation is achieved from δ Y̅r, δ\tilde{Y}r, δs _{r̅}², δt int r and δv int r.

The presentation of the gamma adaption summation, respectively in connection with various r-values and average values as well as median and dispersion characteristics results from a sectional definition of the functional dependency of the gamma adaption summation of the respective average value \tilde{Y} and the respective dispersion value of s_{Y}² in respect to an individual single image. The value for “r” releases the information, as to how many sections are possessed by the function “gamma adaption summations in connection with the average value, the median value and the dispersal value”. By means of the rect₁ function, respectively only that section which is “activated” becomes valid for the values of the average, median and dispersal characteristics. The summation in accord with the equation 7 contains also, independently of r, at the most, a gamma adaption summation for the dependency of the values of the average, median and dispersal characteristics as well as for the intensity of the illumination.

The running variable “u” is the running variable of the potential series development in the equations (8) to (11).

That is to say, in accord with the equations (1) to (6) the following values of the respective single images can be calculated: average, median and dispersion of the brightness or luminance. By the equations (7) to (12) the gamma correction value, namely y, can be obtained for the individual images. These gamma correction values are transferred to a gamma correction unit 10, to which also the image data acquired from the image pickup apparatus 2 has been transmitted. The gamma correction unit 10 carries through, in a familiar fashion, the gamma correction of the submitted images. The gamma correction measures used here are based on the known gamma correction values found in the literature. As a rule, the gamma correction with the luminance component, namely Y(i,j), is present. For this purpose, on the side of the acquiring of the image, that is, the assembly of the image data, the following standardized functional equation is made use of:

$${Y}_{γ} ( i , j ) = {Y ( i , j )}^{\frac{1}{γ}} \qquad ( 13 )$$

The luminescence component Yλ(i,j) is required, in this respect, to contain the following condition, namely 0≦Y_{γ}(i,j)≦1. If necessary, the luminescence components must be standardized before the gamma correction and again removed after the gamma correction. In regard to the details of the above gamma function (13), reference should be made to the text book Fernseh Technology, vol. 2 1991, Hütig Buchverlag Heidelberg, pages 41ff.

The calculation of the equation (13) can be done directly, by means of a potential series development, or by a table or yet by point to point interpolation between the said known points.

Counter to the state of the technology, in the gamma correction unit 10, what is used is not a firmed up gamma correction value, but rather a dynamic gamma correction value which is appropriate for the individual images from the gamma adaption unit 8. The gamma correction image data are then conducted through an output shifting 12 of a display unit 14, for example by an LCD monitor screen. In this way, it becomes possible to give consideration to the gamma correction for the respective unit in an intelligent manner.

What is claimed is:

1. A gamma corrected exterior viewing apparatus comprising:
an image capturing device for mounting on a vehicle for capturing an electronic image exterior to the vehicle;
a computer readable medium in communication with said image capturing device;
an interior display device in communication with said computer readable medium for displaying an electronic image captured by said image capturing device; and,
a set of computer readable instructions embodied in said computer readable medium for receiving electronic image information representing said electronic image, performing an image specific statistical analysis on said electronic image information, determining a gamma correction value according to said image specific statistical analysis so that said electronic image can be displayed on said display device according to said gamma correction value.

2. The system of claim 1 wherein said set of computer readable instructions include instructions for displaying an electronic image according to said electronic image information and said gamma correction value on said display device.

3. The system of claim 2 wherein said set of computer readable instructions include instructions for displaying a second electronic image according to a second electronic image information and said gamma correction value on said display device.

4. The system of claim 1 wherein said set of computer readable instructions include instructions for receiving a plurality of electronic image information from said image capturing device, performing image specific statistical analysis on each electronic image information, and determining a gamma correction value according to said image specific statistical analysis for each electronic image information.

5. The system of claim 4 wherein said computer readable instructions for determining a total gamma correction value according to each of said image specific statistical analysis results.

6. The system of claim 4 wherein said set of computer readable instructions includes instructions for displaying a plurality of electronic images according to said electronic image information and said gamma correction values on said display device.

7. The system of claim 4 wherein said set of computer readable instructions for performing image specific statistical analysis includes performing an average, median and gradation luminance dispersion analysis for each electronic image information.

8. The system of claim 7 wherein said computer readable instructions include instructions for calculating, average, median and gradation analysis results from said average, median and gradation luminance dispersion analysis, summing said gamma correction values, and calculating a total gamma correction value from said average, median and gradation analysis results and said summed gamma correction values.

9. The system of claim 1 wherein said computer readable instructions for performing image specific statistical analysis includes instructions for determining a brightness value of said electronic image information.

10. The system of claim 1 wherein said set of computer readable instructions for performing image specific statistical analysis includes performing luminance dispersion analysis.

11. The system of claim 10 wherein said set of computer readable instructions for performing image specific statistical analysis includes performing an average, median, and gradation luminance dispersion analysis.

12. The system of claim 1 including a vehicle carrying said image capturing device, said interior display device, and said computer readable instructions.

13. The system of claim 12 including a mirror assembly wherein said image capturing device is carried by said mirror assembly.

14. A system for performing gamma correction comprising:
a computer readable medium having electronic image information and in communication with an electronic image capture device and a display device;
a set of computer readable instructions embodied in said computer readable medium for retrieving said electronic image information, performing an image specific statistical analysis on said electronic image information, determining a gamma correction value according to said image specific statistical analysis and so that said electronic image can be displayed on said display device according to said gamma correction value.

15. The system of claim 14 wherein said set of computer readable instructions include instructions for displaying an electronic image according to said electronic image information and said gamma correction value on said display device.

16. The system of claim 15 wherein said set of computer readable instructions include instructions for displaying a second electronic image according to a second electronic image information and said gamma correction value on said display device.

17. The system of claim 14 wherein said set of computer readable instructions include instructions for receiving a plurality of electronic image information from said image capturing device, performing image specific statistical analysis on each electronic image information, and determining a gamma correction value according to said image specific statistical analysis for each electronic image information.

18. The system of claim 17 wherein said computer readable instructions for determining a total gamma correction value according to each of said image specific statistical analysis results.

19. The system of claim 17 wherein said set of computer readable instructions for performing image specific statistical analysis includes performing an average, median and gradation luminance dispersion analysis for each electronic image information.

20. The system of claim 19 wherein said computer readable instructions include instructions for calculating average, median and gradation analysis results from said average, median and gradation luminance dispersion analysis, summing said gamma correction values, and calculating a total gamma correction value from said average, median and gradation analysis results and said summed gamma correction values.

21. The system of claim 14 wherein said computer readable instructions for performing image specific statistical analysis includes instructions for determining a brightness value of said electronic image information.

22. The system of claim 14 wherein said set of computer readable instructions for performing image specific statistical analysis includes performing luminance dispersion analysis.

23. The system of claim 22 wherein said set of computer readable instructions for performing image specific statistical analysis includes performing an average, median and gradation luminance dispersion analysis.
